(19) United States
(12) Patent Application Publication
(10) Pub. No.: US 2026/0358176 A1
(43) Pub. Date: Nov. 12, 2026

(54) INFRARED THERMAL IMAGER CALIBRATION METHOD

(71) Applicant: TOPTEAM TECHNOLOGY TAIWAN CO.,LTD., Taichung City (TW)

(72) Inventor: Wen-Sen Lin, TAICHUNG CITY (TW)

(21) Appl. No.: 19/201,123

(22) Filed: May 7, 2025

(51) Int. Cl. G01J 5/80; G01J 5/00

(52) U.S. Cl. CPC G01J 5/80; G01J 2005/0077

(57) ABSTRACT

An infrared thermal imager calibration method, includes following steps: step S1: an infrared thermal imaging module to perform imaging operation toward a working environment; step S2: the infrared thermal imaging module sending heat source searching signal to a heat source module, the heat source module accordingly generating a heat source, and the heat source undergoing a temperature variation based on a predetermined temperature variation pattern; step S3: the infrared thermal imaging module locking onto the heat source for imaging based on the heat source searching signal and the temperature variation of the heat source, the infrared thermal imaging module sending a temperature calibration signal to the heat source module which accordingly generates a calibration temperature; and step S4: the infrared thermal imaging module obtaining a temperature calibration value based on the calibration temperature. Thus, the present disclosure accurately identifies the heat source of the heat source module and performs calibration.

### BACKGROUND OF THE DISCLOSURE

### 1. Field of the Disclosure

The present disclosure relates to calibration methods, and more particularly, to an infrared thermal imager calibration method.

### 2. Description of the Related Art

Infrared thermal imager is a device used for detecting the temperature of an object using infrared radiation and accordingly generating a thermal image thereof. Such device is mainly applied in fields such as medical care, industry, and surveillance. In a thermal image, different colors represent different temperatures. For example, red color indicates a high temperature, and blue color indicates a low temperature.

However, a conventional infrared thermal imager may experience increased temperature measurement errors after a long period of use. Therefore, infrared thermal imagers need to be calibrated regularly. In addition, different usage environments and detection distances may also affect the measurement results of the infrared thermal imager.

### SUMMARY OF THE DISCLOSURE

The present disclosure aims at providing an infrared thermal imager calibration method and device thereof, so as to accurately identify the heat source of the heat source module and carry out the calibration of the infrared thermal imaging module.

The aforementioned objective does not preclude the existence of other objectives. Any objectives derivable from the specification, claims, or drawings, based on the common knowledge of those skilled in the field of the disclosure are also included within the scope of the objectives of the present disclosure.

For achieving the aforementioned objectives, the present disclosure provides an infrared thermal imager calibration method, comprising following steps:
step S1, using an infrared thermal imaging module to perform an imaging operation toward a working environment;
step S2, the infrared thermal imaging module sending a heat source searching signal to a heat source module disposed in the working environment, the heat source module generating a heat source based on the heat source searching signal, and the heat source undergoing a temperature variation based on a predetermined temperature variation pattern;
step S3, the infrared thermal imaging module locking onto the heat source for imaging operation based on the heat source searching signal and the temperature variation of the heat source, the infrared thermal imaging module sending a temperature calibration signal to the heat source module, and the heat source module generating a calibration temperature based on the temperature calibration signal; and
step S4, the infrared thermal imaging module obtaining a temperature calibration value based on the calibration temperature of the heat source module.

Accordingly, the present disclosure achieves following technical features.

The heat source module of the present disclosure generates a heat source based on the heat source searching signal from the infrared thermal imaging module, enabling the infrared thermal imaging module to locate the heat source in the working environment and perform subsequent temperature calibration process.

On the other hand, when one or more temperature interference sources exist in the working environment, such as humans, animals, household electric appliance, or instruments, the heat source module provided by the present disclosure generates a heat source based on the heat source searching signal, and the heat source undergoes a temperature variation based on a predetermined temperature variation pattern. For example, the temperature of the heat source may rise or drop, or first decrease then increase, or first increase then decrease. Through the temperature variation, the infrared thermal imaging module is allowed to effectively track the heat source of the heat source module.

### BRIEF DESCRIPTION OF THE DRAWINGS

FIG. 1 is a flow chart of the infrared thermal imager calibration method in accordance with an embodiment of the present disclosure.

FIG. 2 is a schematic view of the working environment in accordance with an embodiment of the present disclosure, illustrating each module being applied to the working environment.

FIG. 3 is a schematic view taken from one side of the heat source module in accordance with an embodiment of the present disclosure, illustrating the heating surface of the heat source module.

FIG. 4 is a schematic view taken from another side of the heat source module in accordance with an embodiment of the present disclosure, illustrating the heat source module rotating.

FIG. 5 is a structural block view of the infrared thermal imager calibration device in accordance with an embodiment of the present disclosure, illustrating the coupling relationship among the modules.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion.

Embodiments of the present disclosure are illustrated in detail along with the drawings. However, the technical features included by the present disclosure are not limited to certain embodiments hereby provided. Scope of the present disclosure shall be referred to the claims, which include all the possible replacements, modifications, and equivalent features.

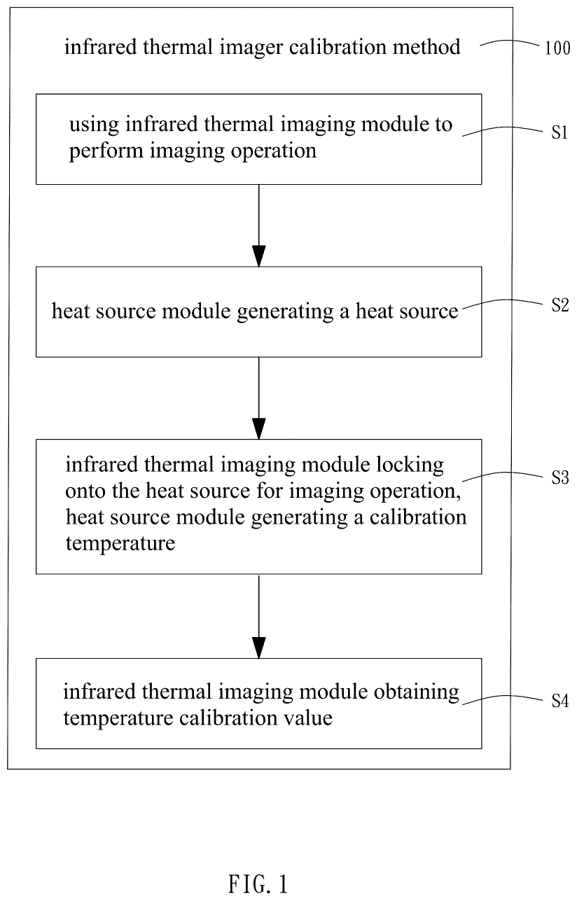

Referring to FIG. 1, an infrared thermal imager calibration method 100 in accordance with an embodiment of the present disclosure is provided, comprising step S1 to step S4.

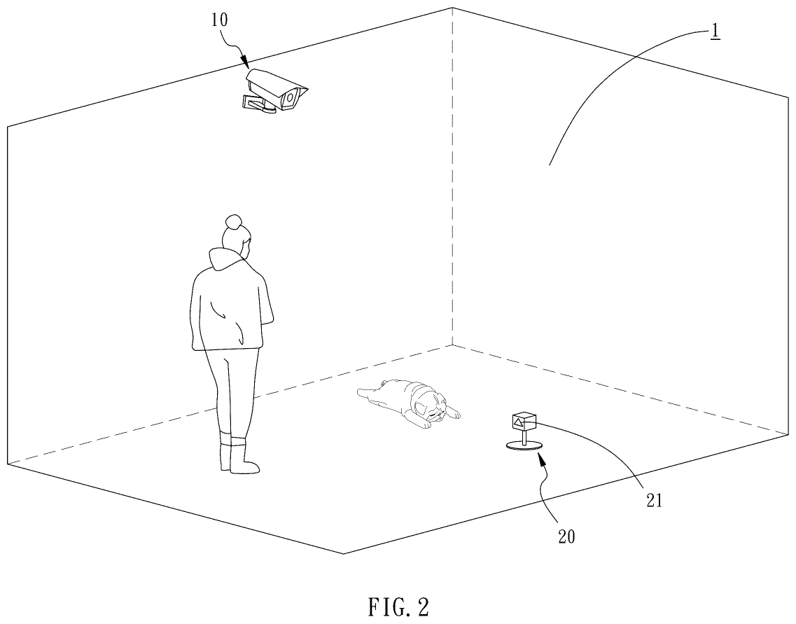

Referring to FIG. 1 and FIG. 2, in step S1, an infrared thermal imaging module 10 is used to perform an imaging operation toward a working environment 1, so as to obtain a thermal image information. Therein, the working environment 1 is allowed to be, for example but not limited to, a school, clinic, hospital, or office.

In step S2, the infrared thermal imaging module 10 sends out a heat source searching signal to a heat source module 20 disposed in the working environment 1. The heat source module 20 generates a heat source 21 based on the heat source searching signal. The heat source 21 undergoes a temperature variation based on a predetermined temperature variation pattern. The temperature of the heat source may, for example but not limited to, rise, drop, first decrease then increase, or first increase then decrease. Accordingly, the infrared thermal imaging module 10 successfully tracks the heat source 21 of the heat source module 20, so as to prevent the temperature interference source (such as humans, animals, household electric appliance, or instruments) in the working environment 1 from interfering the infrared thermal imaging module 10 from tracking the heat source module 20.

In an embodiment of the present disclosure, in step S2, the heat source 21 changes a heating area of the heat source 21 timely based on the predetermined temperature variation pattern. For example, the heating area of the heat source 21 may increase or decrease in size, or even undergoes large and small variations sequentially, in order to be identified by the infrared thermal imaging module 10.

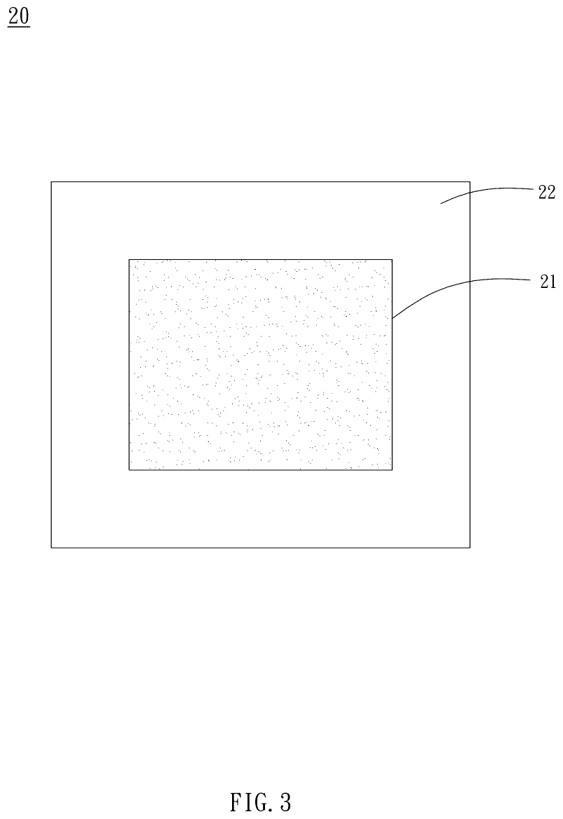

Referring to FIG. 3, in an embodiment of the present disclosure, in step S2, the heat source 21 changes a heating shape of the heat source 21 based on the predetermined temperature variation pattern in order to be identified by the infrared thermal imaging module 10. Therein, the heating shape of the heat source 21 is allowed to be, for example but not limited to, square, circular, triangular, or polygonal shape.

In an embodiment of the present disclosure, the infrared thermal imaging module 10 sends out the heat source searching signal to the heat source module 20 through a wireless signal or a wired signal. Particularly, when the infrared thermal imaging module 10 is configured to send the heat source searching signal to the heat source module 20 through the wireless signal, the heat source module 20 is disposed in the working environment 1, so that the infrared thermal imaging module 10 remotely sends out the heat source searching signal to the heat source module 20; when the infrared thermal imaging module 10 is configured to send the heat source searching signal to the heat source module 20 through the wired signal, the heat source module 20 is disposed in front of the camera of the infrared thermal imaging module 10, so that the infrared thermal imaging module 10 sends out the heat source searching signal to the heat source module 20 in a wired connection manner.

In step S3, the infrared thermal imaging module 10 locks onto the heat source 21 to carry out the imaging operation based on the heat source searching signal and the temperature variation of the heat source 21. The infrared thermal imaging module 10 sends out a temperature calibration signal to the heat source module 20, and the heat source module 20 generates a calibration temperature based on the temperature calibration signal.

For example, when the infrared thermal imaging module 10 locks onto the heat source 21 to carry out the imaging operation, the infrared thermal imaging module 10 sends the temperature calibration signal to the heat source module 20, requesting the heat source module 20 to send out the calibration temperature, such as a temperature higher or lower than the temperature in the working environment 1. When the heat source module 20 receives the temperature calibration signal, the heat source module 20 accordingly generates the calibration temperature based on the temperature calibration signal.

In step S4, the infrared thermal imaging module 10 obtains a temperature calibration value based on the calibration temperature from the heat source module 20, and carries out the subsequent temperature calibration operation.

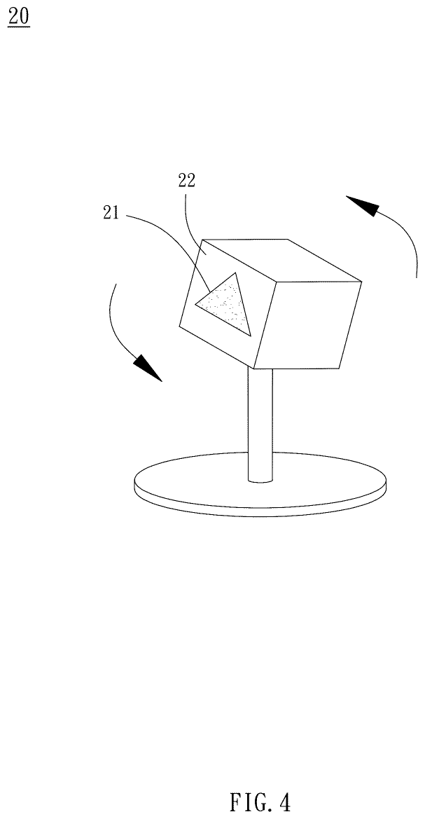

Referring to FIG. 4, in an embodiment of the present disclosure, a heating surface 22 of the heat source module 20 is adjustable. Specifically, in step S2, the infrared thermal imaging module 10 sends out the heat source searching signal to an adjustment module 30 of the heat source module 20 and the heat source module 20 simultaneously; therein, the infrared thermal imaging module 10 sends out the heat source searching signal to the adjustment module 30 of the heat source module 20 and the heat source module 20 through a wireless or wired signal simultaneously. In step S3, the adjustment module 30 adjusts the heating surface 22 of the heat source module 20 based on the heat source searching signal, causing the heating surface 22 of the heat source module 20 to, for example, rotate, tilt, rise, or lower. The infrared thermal imaging module 10 locks onto the heat source 21 to carry out the imaging operation based on the heat source searching signal, the temperature variation of the heat source 21, and the heating surface 22 of the heat source module 20.

In an embodiment of the present disclosure, in step S4, a distance detection module 40 is coupled with the infrared thermal imaging module 10 and carries out a distance detection operation on one or more heat sources 21, and accordingly generates a distance detection data. The infrared thermal imaging module 10 obtains the temperature calibration value based on the calibration temperature from the heat source module 20 and the distance detection data from the distance detection module 40. Accordingly, by using the distance detection data from the distance detection module 40 in combination with the calibration temperature from the heat source module 20, the infrared thermal imaging module 10 compensates for the distance to the heat source 21, whereby the infrared thermal imaging module 10 obtains more accurate temperature data.

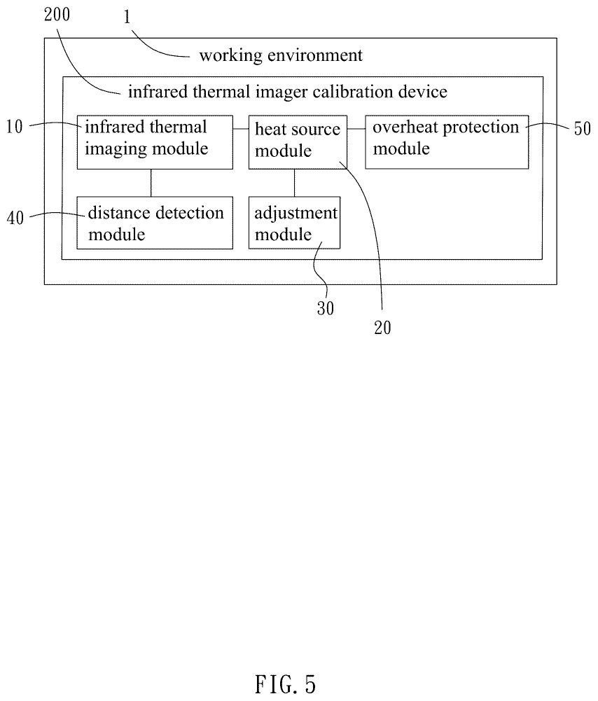

Referring to FIG. 5, in an embodiment of the present disclosure, an infrared thermal imager calibration device 200 is provided, which is disposed in a working environment 1.

The infrared thermal imager calibration device 200 comprises an infrared thermal imaging module 10 and a heat source module 20.

The infrared thermal imaging module 10 performs an imaging operation toward the working environment 1. The heat source module 20 is disposed in the working environment 1. The infrared thermal imaging module 10 sends out a heat source searching signal to the heat source module 20. The heat source module 20 generates a heat source 21 based on the heat source searching signal, and the heat source 21 undergoes a temperature variation based on a predetermined temperature variation pattern. Therein, the infrared thermal imaging module 10 locks onto the heat source 21 to carry out the imaging operation based on the heat source searching signal and the temperature variation of the heat source 21, and the infrared thermal imaging module 10 sends out a temperature calibration signal to the heat source module 20. Particularly, when the temperature variation of the heat source 21 matches the heat source searching signal, the infrared thermal imaging module 10 sends out a temperature calibration signal to the heat source module 20. The heat source module 20 receives the temperature calibration signal, and generates a calibration temperature based on the temperature calibration signal. The infrared thermal imaging module 10 obtains a temperature calibration value based on the calibration temperature from the heat source module 20.

Referring to FIG. 4 and FIG. 5, the infrared thermal imager calibration device 200 further comprises an adjustment module 30 which has a driving mechanism, such as a motor. The adjustment module 30 is disposed in the heat source module 20 to adjust the angle or height of the heat source module 20. The infrared thermal imaging module 10 sends out the heat source searching signal to the adjustment module 30 and the heat source module 20 simultaneously. The adjustment module 30 adjusts a heating surface 22 of the heat source module 20 based on the heat source searching signal for the infrared thermal imaging module 10 to perform the imaging operation. The infrared thermal imaging module 10 locks onto the heat source 21 to carry out the imaging operation based on the heat source searching signal, the temperature variation of the heat source 21, and the heating surface 22 of the heat source module 20.

The infrared thermal imager calibration device 200 further comprises a distance detection module 40, which is coupled with the infrared thermal imaging module 10. Therein, the distance detection module 40 is allowed to be disposed in the infrared thermal imaging module 10. The distance detection module 40 carries out the distance detection operation on one or more heat sources 21, and accordingly generates a distance detection data. The infrared thermal imaging module 10 obtains the temperature calibration value based on the calibration temperature from the heat source module 20 and the distance detection data from the distance detection module 40

The infrared thermal imager calibration device 200 further comprises an overheat protection module 50, which is disposed in the heat source module 20. Therein, the overheat protection module 50 is allowed to be attached to the heat source module 20 to perform a temperature detection operation. The overheat protection module 50 is coupled with the heat source module 20. When the overheat protection module 50 detects that the temperature of the heat source module 20 exceeds a predetermined temperature, the overheat protection module 50 controls the heat source module 20 to stop generating the heat source 21 through a signal.

With the foregoing configuration, technical features of the present disclosure will be illustrated below.

The heat source module 20 allows the infrared thermal imaging module 10 to search the heat source 21 in the working environment 1, so as to facilitate the subsequent temperature calibration operation.

Through the temperature variation of the heat source 21 of the heat source module 20, the infrared thermal imaging module 10 successfully tracks the heat source 21 of the heat source module 20, so as to prevent the temperature interference source in the working environment 1 from interfering the infrared thermal imaging module 10 from tracking the heat source module 20.

The heat source 21 is able to vary into different forms based on the predetermined temperature variation pattern, allowing the infrared thermal imaging module 10 to search the heat source 21, achieving a greater versatility in practical applications.

The adjustment module 30 is applied to adjust the angle or height of the heat source module 20, whereby that the infrared thermal imaging module 10 successfully tracks the heat source module 20 without being affected by object shielding. In another embodiment, the adjustment module 30 also is able to adjust the heat source module 20 to a specific angle or height, enabling the infrared thermal imaging module 10 to identify the heat source module 20 based on such specific angle or height.

By using the distance detection data from the distance detection module 40 in combination with the calibration temperature from the heat source module 20, the infrared thermal imaging module 10 compensates for the distance to the heat source 21, whereby the infrared thermal imaging module 10 obtains more accurate temperature data.

Embodiments of the present disclosure are illustrated in detail along with the drawings. However, the technical features included by the present disclosure are not limited to certain embodiments hereby provided. Scope of the present disclosure shall be referred to the claims, which include all the possible replacements, modifications, and equivalent features.

Although particular embodiments of the disclosure have been described in detail for purposes of illustration, various modifications and enhancements may be made without departing from the scope of the disclosure. Accordingly, the disclosure is not to be limited except as by the appended claims.

What is claimed is:

1. An infrared thermal imager calibration method, comprising following steps:
step S1: using an infrared thermal imaging module to perform an imaging operation toward a working environment;
step S2: the infrared thermal imaging module sending a heat source searching signal to a heat source module disposed in the working environment, the heat source module generating a heat source based on the heat source searching signal, and the heat source undergoing a temperature variation based on a predetermined temperature variation pattern;
step S3: the infrared thermal imaging module locking onto the heat source for imaging operation based on the heat source searching signal and the temperature variation of the heat source, the infrared thermal imaging module sending a temperature calibration signal to the heat source module, and the heat source module generating a calibration temperature based on the temperature calibration signal; and
step S4: the infrared thermal imaging module obtaining a temperature calibration value based on the calibration temperature of the heat source module.

2. The infrared thermal imager calibration method of claim 1, wherein in step S2, the infrared thermal imaging module sends out the heat source searching signal to an adjustment module disposed in the heat source module and the heat source module simultaneously; in step S3, the adjustment module adjusts a heating surface of the heat source module based on the heat source searching signal, and the infrared thermal imaging module locks onto the heat source to carry out the imaging operation based on the heat source searching signal, the temperature variation of the heat source, and the heating surface of the heat source module.

3. The infrared thermal imager calibration method of claim 2, wherein in step S2, the heat source timely changes a heating area of the heat source based on the predetermined temperature variation pattern.

4. The infrared thermal imager calibration method of claim 3, wherein in step S2, the heating area of the heat source increases or decreases in size.

5. The infrared thermal imager calibration method of claim 3, wherein in step S2, the heat source changes a heating shape of the heat source based on the predetermined temperature variation pattern.

6. The infrared thermal imager calibration method of claim 5, wherein in step S2, the heating shape of the heat source is selected from a group consisting of square, circular, triangular, and polygonal shape.

7. The infrared thermal imager calibration method of claim 2, wherein in step S2, the infrared thermal imaging module sends out the heat source searching signal to the adjustment module and the heat source module simultaneously through a wireless signal or a wired signal.

8. The infrared thermal imager calibration method of claim 2, wherein in step S4, a distance detection module coupled with the infrared thermal imaging module carries out a distance detection operation on one or more said heat sources, and accordingly generates a distance detection data; the infrared thermal imaging module obtains the temperature calibration value based on the calibration temperature from the heat source module and the distance detection data from the distance detection module.
